(19) United States
(12) Patent Application Publication
(10) Pub. No.: US 2011/0225484 A1
(43) Pub. Date: Sep. 15, 2011

(54) Cloud based modeling for enhancing spreadsheets

(75) Inventors: David LOTAN-BOLOTNIKOFF, Zur Moshe (IL); Elizabeth Gutt, Raanana (IL)

(73) Assignee: SAP Portals Israel Ltd, Raanana (IL)

(21) Appl. No.: 12/721,569

(22) Filed: Mar. 11, 2010

(51) Int. Cl. G06F 3/14

(52) U.S. Cl. 715/212

(57) ABSTRACT

A method and development tool for developing an application over a spreadsheet, the development tool comprising design components for designing a user interface element, a logic-related element that consumes a service from the spreadsheets. and a connector connecting the user interface element and the logic-related element; a communication component; code generation components for generating code associated with the user interface element, code associated with the logic-related element, code associated with the connector, and code associated with communication; and a deployment component for deploying an application based on the code. The method and development tool enable the creation of applications over a spreadsheet, the applications comprising both user interface and business logic. The application can be executed as a web service, and also in a cloud computing environment.

### TECHNICAL FIELD

The present disclosure relates to creating applications in general, and to a method and development tool for creating applications over spreadsheets, in particular.

### BACKGROUND

Many people nowadays use spreadsheets on a daily basis for multiple needs, whether for work purposes or for private purposes, in order to store their data, manipulate it, create reports and manage their activities.

In work environments, an employee of an organization cannot always receive the resources or precedence to have the Information Technology (IT) personnel of the organization provide him with a tailored application. For example, a warehouse manager can use the available warehouse applications, but for more specific or ad-hoc needs, such as irregular information slicing or sorting, it may be the case that there is no available application that provides the requirements.

In another example, a person requiring financial planning, or a person planning an event such as a conference may need to maintain the data such as presenters, invitee list, seating arrangements, payments, and other aspects of the event.

Very often such persons use spreadsheets for such purposes. Thus, spreadsheets are used to maintain, manipulate, apply business logic, and otherwise use data, wherein many of these uses are non-trivial. Although applications providing the required functionalities can be programmed, spreadsheet users are not necessarily programmer and cannot create such applications, therefore their abilities are limited to the options provided by the spreadsheet.

Yet another problem with using a spreadsheet in this manner relates to sharing spreadsheets between multiple users. First, although such spreadsheets may seem clear and intuitive to their creator, they may not be considered user-friendly by other persons who may not fill the required data at the right locations. A further reason relates to updating such spreadsheets, particularly by multiple users who do not have access to common resources such as shared storage.

There is thus a need in the art for a method and development tool for creating user-friendly applications over a spreadsheet. The applications should enable the updating of the underlying spreadsheet by multiple users who may not have access to the same storage device.

### SUMMARY

A method and development tool for creating an application over a spreadsheet is provided. A first aspect of the disclosure relates to a method for generating an application over a spreadsheet, comprising: receiving a description of a user interface element; receiving a description of a logic-related element, the element consuming a service from the spreadsheet; receiving a description for a connector connecting between the user interface element and the service consuming element; and automatically generating code associated with the user interface element, code associated with the service consuming element, and code associated with the description of the connector connecting between the user interface element and the service consuming element. The method can further comprise compiling the code into an application. The method can further comprise deploying an application based on the code. Within the method, the service is optionally selected from the group consisting of: reading all records from the spreadsheet; reading a record from the spreadsheet; adding a record to the spreadsheet; updating a record in the spreadsheet; deleting a record from the spreadsheet; updating a multiplicity of records; and a service provided by the spreadsheet. Within the method, the application is optionally executed as a web application. Within the method, the application is optionally executed in a cloud computing arrangement.

Another aspect of the disclosure relates to a development tool for developing an application over a spreadsheet, comprising: design components for designing a user interface element, a logic-related element that consumes a service from the spreadsheets, and a connector connecting between the user interface element and the logic-related element; a communication component; code generation components for generating code associated with the user interface element, code associated with the logic-related element, code associated with the description of the connector connecting between the user interface element and the logic-related element, and code associated with communication; and a deployment ao component for deploying an application based on the code. Within the development tool, the code generation components optionally comprise: an infrastructure code generation component; a communication and service consumption code generation component; and a user interface handling code generation component. Within the development tool, the application is optionally executed as a web application or in a cloud computing arrangement. Within the development tool, the service is optionally selected from the group consisting of: reading all records from the spreadsheet; reading a record from the spreadsheet; adding a record to the spreadsheet; updating a record in the spreadsheet; deleting a record from the spreadsheet; updating a multiplicity of records; and a service provided by the spreadsheet.

Yet another aspect of the disclosure relates to a computer readable storage medium containing a set of instructions for a general purpose computer, the set of instructions comprising: receiving a description of a user interface element; receiving a description of an element, the element consuming a service from the spreadsheet; receiving a description for a connector connecting between the user interface element and the service consuming element; and automatically generating code associated with the user interface element, code associated with the service consuming element, and code associated with the description of the connector connecting between the user interface element and the service consuming element.

### BRIEF DESCRIPTION OF THE DRAWINGS

Exemplary non-limited embodiments of the disclosed subject matter will be described, with reference to the following description of the embodiments, in conjunction with the figures. The figures are generally not shown to scale and any sizes are only meant to be exemplary and not necessarily limiting. Corresponding or like elements are designated by the same numerals or letters.

FIG. 1 is a schematic illustration of the entities involved in creating an application over a spreadsheet, in accordance with the disclosure;

FIG. 2 is a schematic illustration of the entities involved in using an application over a spreadsheet, in accordance with the disclosure;

FIG. 3 is a schematic illustration of a screen shot of an exemplary application being developed, in accordance with the disclosure;

FIG. 4 is a schematic illustration of a screen shot of designing the input and output of an exemplary application, in accordance with the disclosure;

FIG. 5 is a schematic illustration of a screen shot of designing the mapping between input and usage of data in an exemplary application, in accordance with the disclosure;

FIG. 6 is a schematic illustration of a screen shot of editing an expression in an exemplary application, in accordance with the disclosure;

FIG. 7 is a schematic illustration of a screen shot of associating an element with a service in an exemplary application, in accordance with the disclosure;

FIG. 8 is a schematic illustration of the main components in an application development tool, in accordance with the disclosure; and

FIG. 9 is a schematic flowchart of the main steps in a method for creating an application using an application development tool, in accordance with the disclosure.

### DETAILED DESCRIPTION

The current application relates to and hereby specifically incorporates by reference the entire contents and disclosure of the following references: U.S. application Ser. No. 10/712,771 filed Nov. 12, 2003 titled “Modeling System for Graphic User Interface”, granted on Aug. 12, 2008 as U.S. Pat. No. 7,412,658; U.S. application Ser. No. 12/163,897 filed Jun. 27, 2008 titled “Modeling System for Graphic User Interface”, granted on Dec. 22, 2009 as U.S. Pat. No. 7,636,895; U.S. application Ser. No. 12/613,250 filed Nov. 5, 2009 titled “Modeling System for Graphic User Interface”; U.S. application Ser. No. 11/182,725 filed Jul. 15, 2005 titled “Declarative Specification of Model Visualizations”, granted on Dec. 9, 2008 as U.S. Pat. No. 7,463,263; U.S. application Ser. No. 11/454,610 filed Jun. 16, 2006 titled “Programming Language Techniques for Client-Side Development and Execution”; U.S. application Ser. No. 11/324,155 filed Dec. 29, 2005 titled “Executable Declarative Specification for Graphical User Interfaces”; U.S. application Ser. No. 11/823,173 filed Jun. 27, 2007 titled “Design-Time Rules Mechanism for Modeling Systems”.

A method and development tool for developing applications over spreadsheets. The method and development tool provide a visual tool for developing applications in a graphic manner, so that no programming or coding is required. The developed application uses the spreadsheet, such as a Microsoft Excel spreadsheet as a backend system, and activates services which allow retrieval or manipulation of the data in the spreadsheet, and provides user interface and business logic utilizing and updating the data within the spreadsheet.

The development tool comprises a development environment which reads or otherwise obtains a spreadsheet structure, and provides graphic tools with which the application developer creates an application utilizing the spreadsheet structure. The application comprises the user interface as designed by the developer, and code generated by the tool which provides the application with business logic.

When the application is used by a user (not necessarily the developer), the user of the application is provided with the developed user interface, and the code generated during the creation is activated. In some embodiments the user will perform actions and interact with the associated spreadsheet as was defined during the application development. The development environment equips the application, in association with the spreadsheet, or even with each page within the spreadsheet, with services, which may include but are not limited to the following services: listing of all records; creating a new record; reading an existing record; updating an existing record; and deleting a record. The developer can build an application which uses any of these services, manipulates the data using functionalities as provided the spreadsheet, receives data or services from an external source, such as Web Services, and lets a user of the application enter data.

The applications created may be provided as Web applications, so that no installation or deployment is required by the user.

For example, a person planning an event may create a spreadsheet with a row to be populated with the details of each invitee, and an application that lets an invitee fill in his details in a user friendly manner. The application may further let the spreadsheet owner manipulate all entered data, for example to obtain the details of all invitees, the total invitees number and the number of invitees from each area for organizing transportation. The developer can then put the application online and send the link to all invitees. Each invitee will then at his convenience, activate the application and add his details which will be added to the spreadsheet. Eventually the developer will access the spreadsheet, either directly or through another part of the application and will obtain all required data.

In some embodiments, the application can be used in a cloud computing environment, in which a scalable number of servers are allotted for users of the application, without affecting the end user's experience.

In cloud computing environments, the customer, who in the current case is the application owner, does not own the computing platforms which execute the application, but rather rents usage from a third-party provider. The application is provided to the user as a service, and payment is determined in accordance with the consumed resources, or on a subscription basis.

Cloud computing enables efficient usage of resources. Multiple computing platforms can be shared among users who own multiple applications, wherein in most cases peak demand will occur at different times for different applications. Thus, instead of each user owning a multiplicity of platforms so that service is ensured for peak loads while most of the time many of the platforms are idle, cloud computing arrangement enables multiple users to share the same platforms, so that the usage of each computer rises. However, the disclosed method and apparatus are not limited to being used in cloud computing environments, and can be used in other environments as well, such as hosting services.

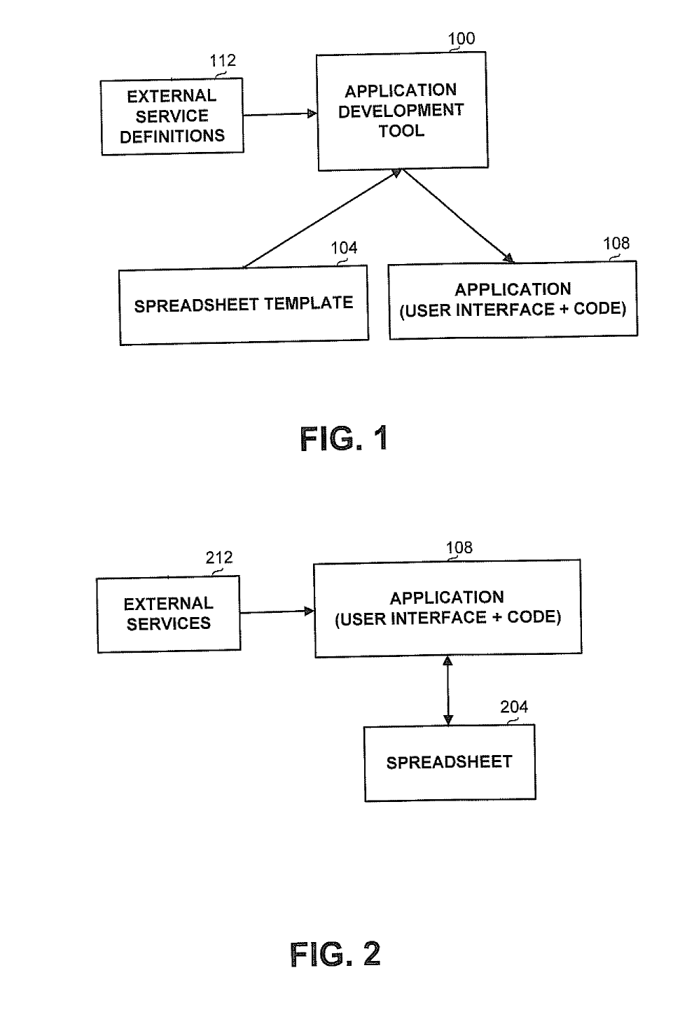

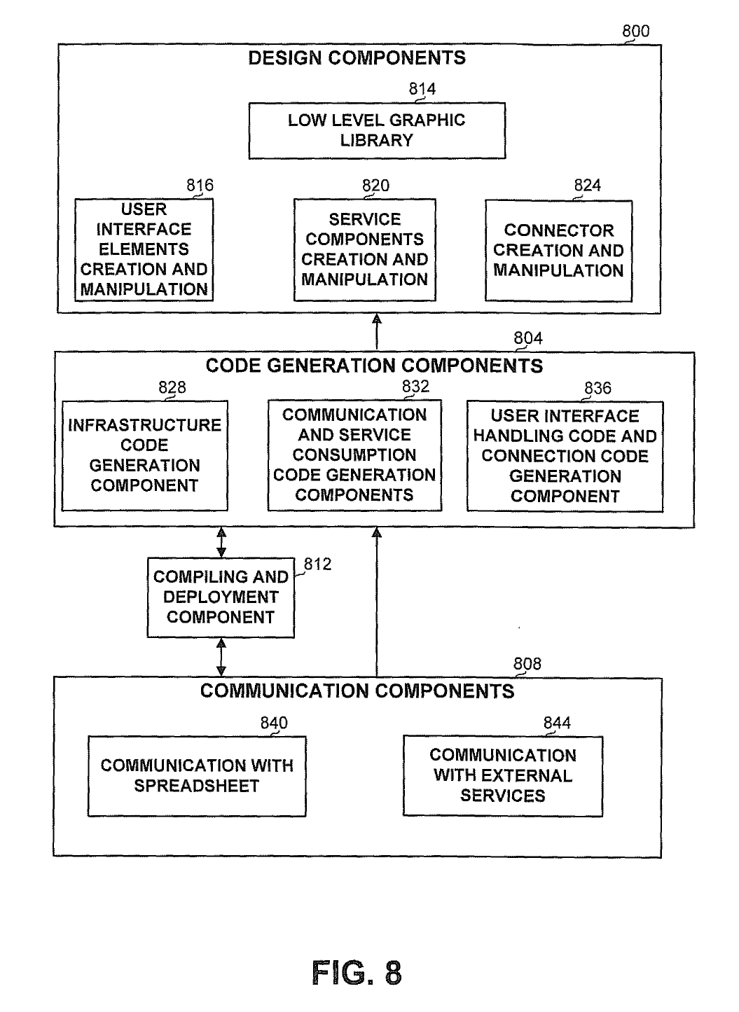

Referring now to FIG. 1, showing a general scheme of the components and data flow in developing an application over a spreadsheet. The user in the scheme of FIG. 1 is an application developer, who uses application development tool 100, detailed in association with FIG. 8 below for developing an application. Application development tool 100 obtains or receives spreadsheet template 104, which comprises the template of a spreadsheet comprising one or more pages. The template comprises at least a header row or column in at least a page of the spreadsheet. For example in a spreadsheet comprising a table of bank name and bank country, a header row may include a bank_name cell and a bank_country cell, both of string type. Application development tool 100 may use one or more external service definition 112, which will be consumed by the developed application. Such services can be obtained from any source, such as an existing application, a web service, or the like. An exemplary service can be a stock quote, a zip code associated with an address, or any other service.

Application development tool 100 provides a developer that creates an application with tools for generating the user interface of the application. Application development tool 100 further generates the code for the application in an automatic manner. The output of the development stage is an application 108, which comprises user interface and code, and is designed to work with a spreadsheet complying with spreadsheet template 104 and optionally to consume services complying with external service definitions 112.

Referring now to FIG. 2, showing a schematic illustration of the components and usage of an application generated by the system of FIG. 1. The user in the scheme of FIG. 2 is an end-user of the application developed by the application developer. The components include application 108 as created using application development tool 100 of FIG. 1. Application 108 comprises user interface as designed by the application creator, and automatically generated code.

Application 108 receives spreadsheet 204 which complies with spreadsheet template 104. Application 108 may use any one or more of services 212 which may be external to the application, and which comply with external service definitions 112.

Application 108 optionally saves information back to spreadsheet 204. Application 108 may add, delete or update the information of spreadsheet 204, depending on the application user's options and activities.

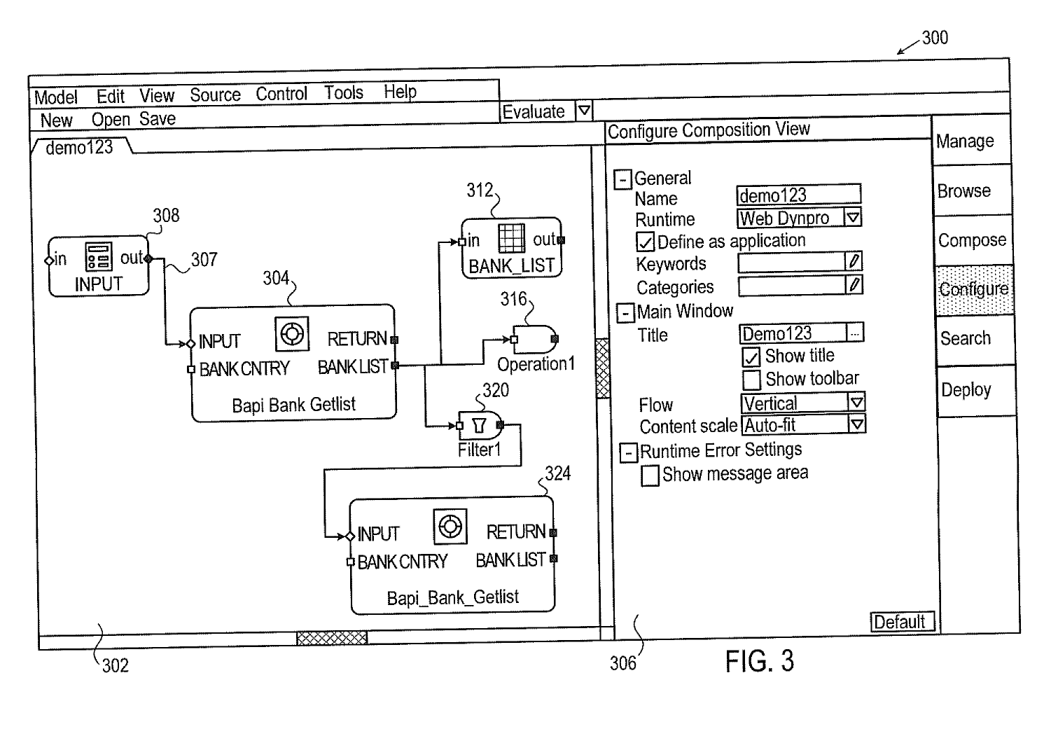

Referring now to FIG. 3-FIG. 7, describing operations for generating an exemplary application on top of an exemplary spreadsheet containing a bank table, wherein the table contains for each bank a bank country, bank city and bank name.

Referring now to FIG. 3, showing an exemplary design of the application being developed by a user.

Left hand side pane 302 of screen 300 of the development environment enables a user to design the application, while right hand side pane 306 lets the user define general characteristics of the application.

As detailed above, the development tool provides services of listing all records, reading a record that complies with a certain criteria, such as ID updating a record, adding a new record, and deleting a record.

The application of FIG. 3 can thus utilize a service of the spreadsheet that receives as input values of one or more fields out of the bank country, bank city and bank name fields, and returns a list of all banks that comply with the given values.

Element 304 therefore represents a usage of this service. The input to element 304 is provided by form 308 through link 307. The output of the service represented by element 304 is used in three exemplary usages.

One usage is by table 312 that lists the records returned by the service represented by element 304.

Another usage is by element 316 that provides the result of an operation performed over the results returned by element 304. The result can be obtained using any relevant operation provided by the underlying spreadsheet. For example, the records can be aggregated, mathematical operations can be performed over numerical fields, text manipulations can be performed over textual fields, or the like

The results output by element 304 can also be manipulated by filter 320 which enables filtering in accordance with any static or dynamic expression associated with any one or more fields of the results as provided by the underlying spreadsheet and output by element 304. The filtered records are input to a further element 324 which may use the same service as element 304. No usage is specified for the list output by element 324 in the exemplary application of FIG. 3.

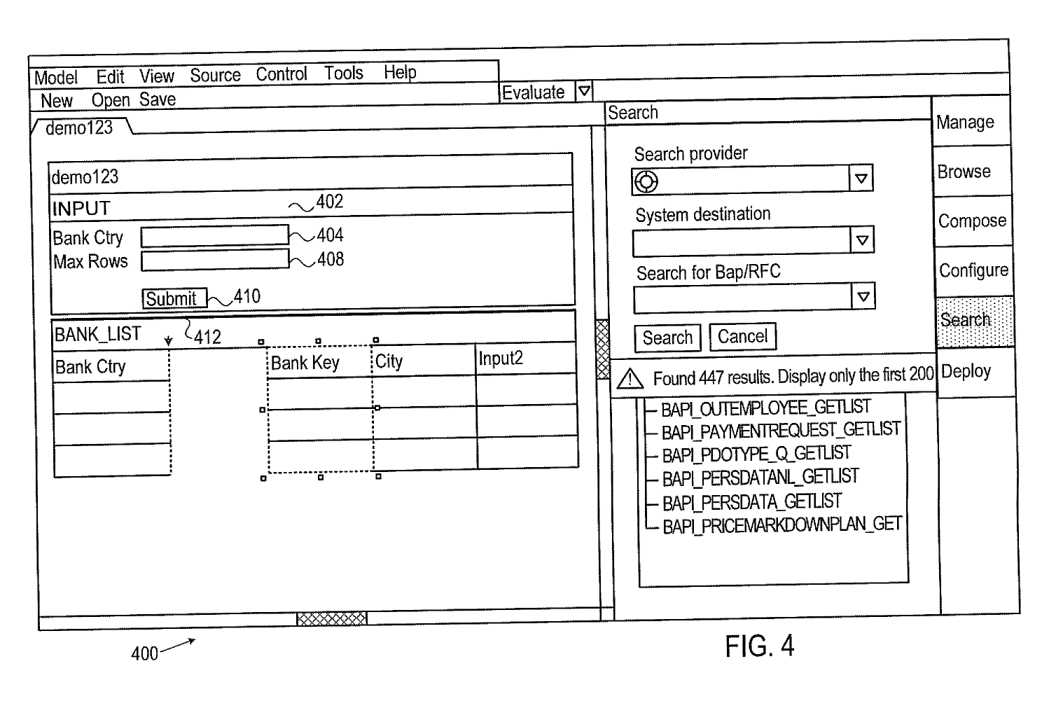

Referring now to FIG. 4, showing a screen 400 for providing the designs of input form 308 and bank_list table 312 FIG. 3.

In the exemplary design of FIG. 4, input form 308 is edited using area 402, in which the application developer indicated using graphic tools that a user of the application will be presented with bank country input field 404, maximal number of rows input field 408, and a submit button 410.

In Bank_list design area 412, the application developer indicated that the information presented by bank list table 312 of FIG. 3 will present the bank country, bank key, city and additional input. The application developer can indicate the required columns, their order, width and optionally additional parameters.

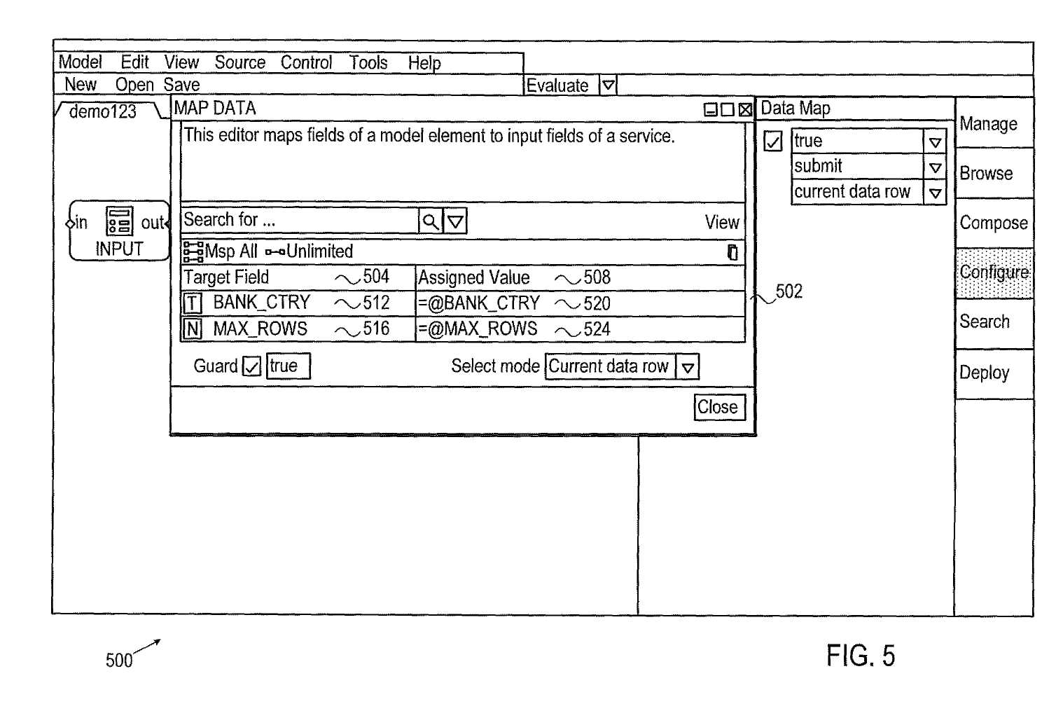

Referring now to FIG. 5, showing an exemplary design of the mapping between input form 308 and element 304, as performed by link 307, all of FIG. 3. Link 307 connects the output of form 308 to the input of element 304.

The mapping design, generally referenced 500 comprises pane 502 which presents a table. The table comprises a row for each field input via form 308, as detailed in association with FIG. 4 above, and enables to user to associate the field with an input required by element 304.

Thus, bank country 512 as will be entered on field 404 of FIG. 4 by the application user, is mapped to @BANK_CTRY input 520 of element 304, and max rows value 516 as will be entered on field 408 of FIG. 4 by the application user, is mapped to @MAX_ROWS input 524 of element 304.

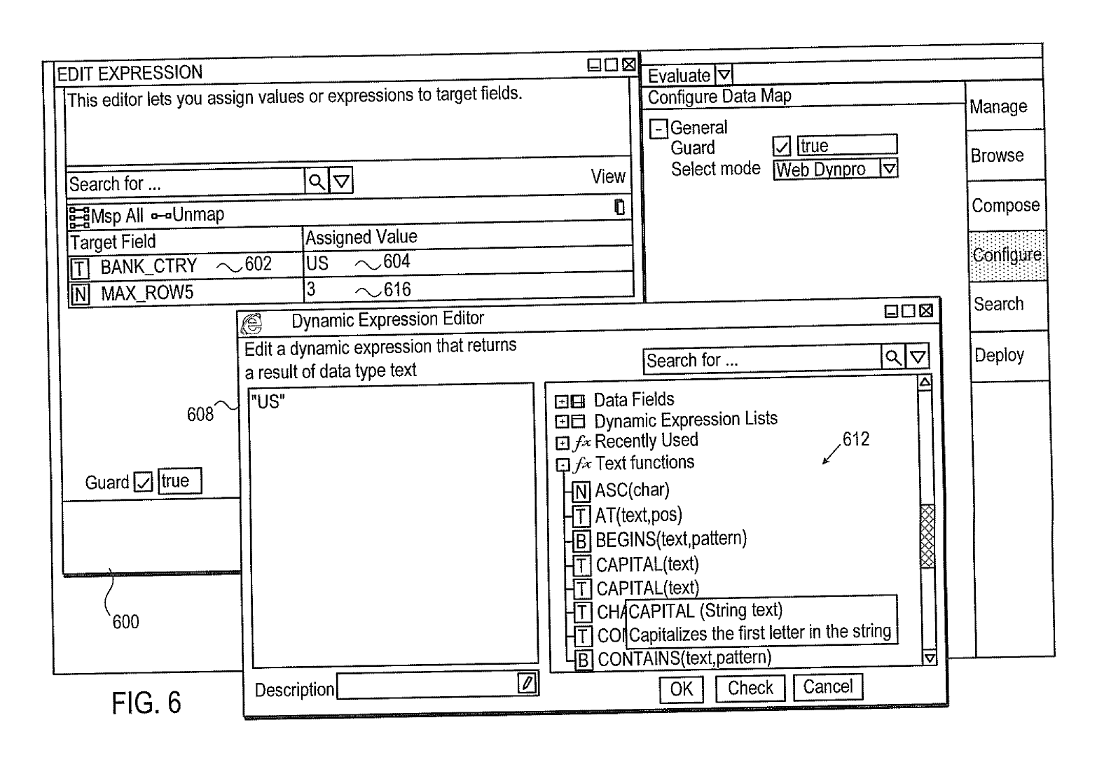

Referring now to FIG. 6, showing screen 600 for editing an expression to be used by an element such as element 304, filter 320 or any other component of the developed application.

Screen 600 shows window 608 opened for editing textual field 602 of BANK_CTRY. Window 608 comprises text which can be entered on field 604, or otherwise obtained, for example through input form 308. Window 608 further comprises list 612 of operators that can be activated on the string, such as computing its ASCII value, concatenating, switching between lower and capital letters, or any other operation applicable for a textual field.

When editing a field of another type, such as numeric field 616, operations applicable for a numeric field will be presented.

It will be appreciated that the expression editor can be used for editing expressions associated with any component of the application, including for example operation 316, filter 320, elements 304 or 324, or input form 308.

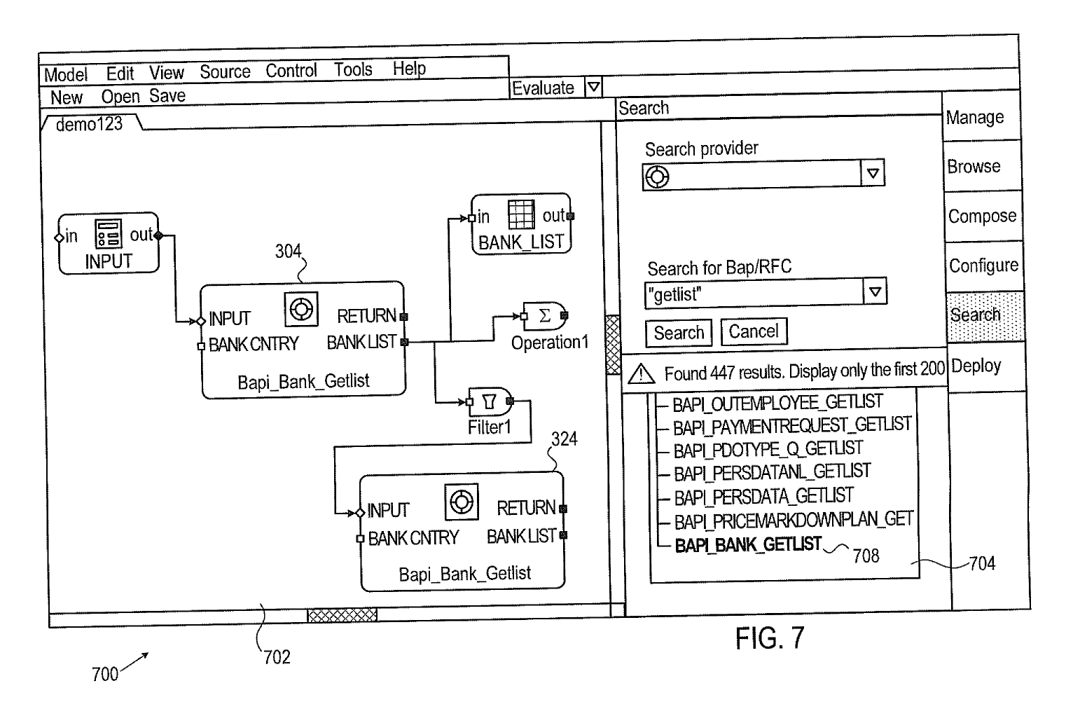

Referring now to FIG. 7, showing screen 700 for associating an element with a relevant service.

Screen 700 comprises left hand pane 702 showing the diagram created by the application developer, as shown also on pane 302 of FIG. 3. Screen 700 also comprises a list 704 which comprises the services available to the developer. The services are enabled by the development environment, and depend on the template of the underlying spreadsheet. For example, the list shown in FIG. 7 comprises BAPI_BANK_GETLIST service 708, and is selected for element 304 in the developed exemplary application. The services can also include external services, for example obtaining a stock quote.

The correspondence between the input required for the service, and the input to the element created by the developer is verified. Thus, it is verified that BAPI_BANK_GETLIST can receive as input a bank country string and a maximum number of rows, and will return at most the maximal number of banks in the indicated country.

Once the application is designed, including the functionality as expressed by designing the components and consumed services, matching fields and applying operators, and the user interface, the relevant code is generated, and optionally compiled and deployed. The application can then be used by an end-user, and can automatically upload a spreadsheet when started, and download the spreadsheet when finished.

Referring now to FIG. 8, showing a schematic illustration of the main components in a development tool, also referred to as modeling tool or development environment for developing applications. The development tool provides an application developer with the tool for defining and designing an application over a spreadsheet as exemplified in FIG. 3-FIG. 7 above.

The development tool enables application developers such as business process experts and developers to create and adapt model-based transactional and analytical applications without coding or programming, thus minimizing the effort and time required for creating an application.

The developers apply their understanding of the domain requirements and knowledge of their environment to accomplish the various goals and map the processes and logical flow of the required applications.

The tool features a visual user interface that streamlines application so development, enabling users to model applications by dragging and dropping elements, rather than manually writing code. The applications process data on top of spreadsheets, while using services provided by the spreadsheet as well as other services.

The tool enables the modeler or the application developer to determine the visual layout of the application, as well as the data structure, data flow, and event flow in the application.

The tool can compile or interpret models in accordance with different user interface technologies, such as Web Dynpro which is a runtime environment supplied by SAP AG of Waldorf, Germany, Flash which is a runtime environment supplied by Adobe Systems of San Jose, Calif., USA, or other technologies.

The tool is optionally web-based, thus eliminating the need for client-side installation and maintenance, and enabling operation on top of a single spreadsheet.

In order to provide for a uniform operation, a constant set of services is provided by any developed application with respect to any spreadsheet, including loading all records, reading a record, adding, updating and deleting a record. It will be appreciated that additional or different services may exist as well, such as “Update All Records”.

The tool provides an application developer with a workspace, which contains a board for constructing the model and defining the flow between model elements, and for laying out the user interface (UI) controls in the views of the application model.

The options available for each element are dynamic and context-driven, so that only options relevant to a model element currently selected in the workspace are displayed. For example, if a dropdown list control is displayed on the layout board, only properties that are relevant to a dropdown list control are enabled.

An application is generated by defining application functionality and manipulating visual elements rather than by programming.

The model elements provide data services, user interface elements and connections between such elements. The data services can include services provided by the underlying spreadsheet, relationships, logical flow, and event flow between the model elements and application parts. The user interface elements are defined by their appearance, control, and behavior.

The development tool comprises visual library 800, code generation components 804, communication components 808, and compiling and deployment components 812.

Visual library 800, code generation components 804 and communication components 808 can be programmed in any programming language such as C, C#, C++, Java or others, and under any development environment. The development environment can be executed on any computing platform, such as a server, a desktop computer, a laptop computer, a network computer, or any other computing platform comprising a processing unit (CPU) and memory. The development environment can also be executed as a web service accessed by a client computing platform used by an application developer.

Design components 800 let a user create and define the graphic elements of the application he or she is developing, and associate the elements with domain-related entities. In some exemplary embodiments, design components 800 thus contain low level graphic library 814 which provides the user with tools for describing the layout of the application, such as tools for creating and drawing geometric shapes, connecting lines, text and the like.

Design components 800 further comprise user interface elements creation and manipulation components 816, which provide for generating more complex graphic elements, visual elements, or user interface elements, such as tables, forms, or the like, for displaying data to a user and receiving data from a user.

Service elements creation and manipulation component 820 enables a user to associate a graphic element with a provided service, data, data source or another domain-related entity, such as a service provided by an application, a database table, information returned by a response to a query, or others. Service elements creation and manipulation component 820 can also provide a user with the option to manipulate data, including for example mathematical manipulations of numerical fields, textual manipulation of text fields, or the like.

Design components 800 also contain connector creation and manipulation component 824 for connecting a first element and a second element, wherein any of the first or second elements can be a visual element or a service component. Connector creation and manipulation component 824 assigns meaning to a graphical connection between elements, including for example mapping between fields of an input form and parameters required for a service, mapping between database columns of different tables, manipulating values associated with the first element before using them as input to the second element, or the like.

Communication components 808 enables the communication of the environment with additional entities. Communication with spreadsheet component 840 provides operations such as reading and writing to and from a spreadsheet, including reference to multiple pages, reading and writing records, reading the spreadsheet template such as header row, obtaining the definition and interface of services and operations supported by the spreadsheet, and performing operations on the spreadsheet.

Code generation components 804 receive the application definition as designed by the developer, generate the relevant code and add additional predetermined pieces of code. Code generation components 804 thus generate the code so that a developer can develop a computerized application without programming. The generated code will be compiled, interpreted, and deployed by compiling and deployment components 812. Thus, code generation components 804 actually create the code of the application to be used by the end user of the developed application.

Code generation components 804 comprise infrastructure code generation components 828 which provides general and infrastructure code, such as file manipulations, user administration, privilege management, or the like.

Code generation components 804 further comprise communication and service consumption code generation components 832 for generating code for communicating with the underlying spreadsheet, such as adding, retrieving, deleting and updating records, and for consuming services from external sources as well. The code is associated with the relevant components created by an of design components 800. Thus, a visual element is associated with code that presents or receives data, a service consuming element is associated with consuming services and manipulating data objects.

Code generation components 804 also comprise user interface handling code and connection code generation component 836 which generates code that handles the user's actions, such typing text within textual fields, or the like, and optionally the connectors' code.

Code generation components 804 can generate code in any required programming language, such as C, C#, C++, Java or others, or a combination of two or more programming languages. Some of the code can also be in XML or a derivative thereof.

When all code is generated, the code is compiled, interpreted or is otherwise made ready for deployment by compiling and deployment components 812. The compilation process depends on the particular language in which the code was generated, the development environment and the destination environment on which the application is to be executed. In some alternatives, the code can be compiled to multiple destination environments.

The compiled application can be used as a web application, so that no deployment is required by a user. In a further alternative, the application can be used in cloud computing, in which a scalable number of servers are allotted for users of the application, without affecting the end user's experience.

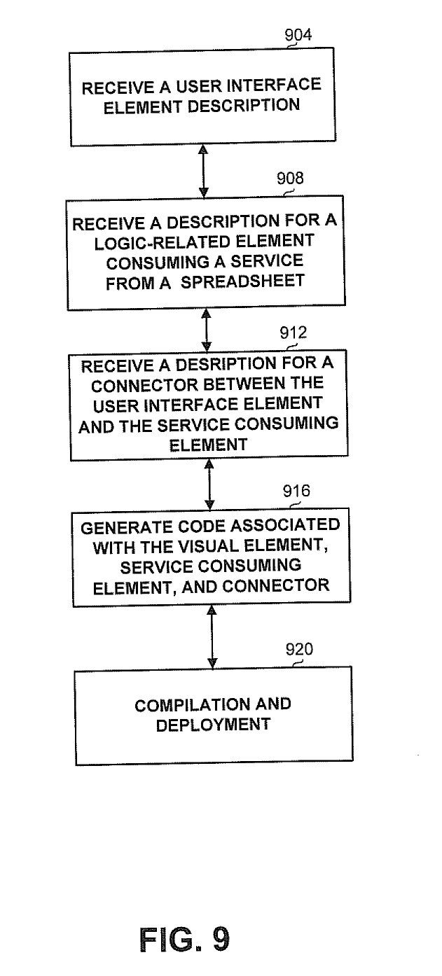

Referring now to FIG. 9, showing a schematic flowchart of the main steps in a method for creating an application over a spreadsheet without coding.

On step 904, a representation of user interface element or a visual element, such as a control is received from a user. The representation includes appearance characteristics such as control type, control size, location, color, or the like. The characteristics further include relevant data items to be displayed by the control, and data types of values to be received from a user of the application.

On step 908, a representation is received of a logic-related element which consumes a service from a spreadsheet. The representation includes the service to be consumed from the spreadsheet, the input to the service and optional filters. The service may be any service provided by the spreadsheet, as well as the services provided by the environment, including reading all records, reading a record, adding, deleting and changing a record. The element thus provides business logic associated with the application.

On step 912, a connection or connector between two elements is received, wherein any of the elements can be a user interface element such as a visual element, or a service consuming element. The connection can comprise mapping from the relevant fields of the first element to the relevant field at the second element.

It will be appreciated that elements may exist of additional types, such as data manipulation elements which receive or obtain data and manipulate it, but do not consume a service from the spreadsheet. Also, composite or container elements can be provided as well, which contain further visual elements, service consuming elements, or connectors.

On step 916 code is generated automatically according to the visual elements, service consuming elements, the connectors, and additional elements. Additional code may be provided for infrastructure such as file manipulation, user administration, privilege administration, communication, or the like. In some embodiments, the code includes loading the relevant spreadsheet when the application starts. The code may further comprise handling “Save” or “Commit” commands for updating the spreadsheet when the application exists.

On step 920 the code is compiled, if the language at which the code is written requires compilation, and deployed.

It will be appreciated that the block diagram and flow chart of FIGS. 8 and 9 are exemplary only, and that different embodiments can be designed, having different, fewer or additional components or steps.

The description above refers also to a computer readable storage medium containing a set of instructions for a general purpose computer for executing the steps described above. Such storage medium can be but is not limited to a mass storage device, for example an optical storage device such as a CD, a DVD, or a laser disk; a magnetic storage device such as a tape or a hard disk; a semiconductor storage device such as Flash device, memory stick, or the like.

It will be appreciated by a person skilled in the art that multiple variations and options can be designed along the guidelines of the disclosed method and development tool.

While the disclosure has been described with reference to exemplary embodiments, it will be understood by those skilled in the art that various changes may be made and equivalents may be substituted for elements thereof without departing from the scope of the disclosure. In addition, many modifications may be made to adapt a particular situation, material, step or component to the teachings without departing from the essential scope thereof. Therefore, it is intended that the disclosed subject matter not be limited to the particular embodiment disclosed as the best mode contemplated for carrying out this disclosure, but only by the claims that follow.

1. A method for generating an application over a spreadsheet, comprising:
receiving a description of a user interface element;
receiving a description of a logic-related element, the element consuming a service from the spreadsheet;
receiving a description for a connector connecting between the user interface element and the service consuming element; and
automatically generating code associated with the user interface element, code associated with the service consuming element, and code associated with the description of the connector connecting between the user interface element and the service consuming element.

2. The method of claim 1 further comprising compiling the code into an application.

3. The method of claim 1 further comprising deploying an application based on the code.

4. The method of claim 1 wherein the service is selected from the group consisting of: reading all records from the spreadsheet; reading a record from the spreadsheet; adding a record to the spreadsheet; updating a record in the spreadsheet; deleting a record from the spreadsheet; updating a multiplicity of records; and a service provided by the spreadsheet.

5. The method of claim 3 wherein the application is executed as a web application.

6. The method of claim 3 wherein the application is executed in a cloud computing arrangement.

7. A development tool for developing an application over a spreadsheet, comprising:
design components for designing a user interface element, a logic-related element that consumes a service from the spreadsheets, and a connector connecting between the user interface element and the logic-related element;
a communication component;
code generation components for generating code associated with the user interface element, code associated with the logic-related element, code associated with the connector connecting between the user interface element and the logic-related element, and code associated with communication; and
a deployment component for deploying an application based on the code.

8. The development tool of claim 7 wherein the code generation components comprise:
an infrastructure code generation component;
a communication and service consumption code generation component; and
a user interface handling code generation component.

9. The development tool of claim 7 wherein the application is executed as a web application.

10. The development tool of claim 7 wherein the application is executed in a cloud computing arrangement.

11. The development tool of claim 7 wherein the service is selected from the group consisting of: reading all records from the spreadsheet;
reading a record from the spreadsheet; adding a record to the spreadsheet;
updating a record in the spreadsheet; deleting a record from the spreadsheet;
updating a multiplicity of records; and a service provided by the spreadsheet.

12. A computer readable storage medium containing a set of instructions for a general purpose computer, the set of instructions comprising:
receiving a description of a user interface element;
receiving a description of an element, the element consuming a service from a spreadsheet;
receiving, a description for a connector connecting between the user interface element and the service consuming element; and
automatically generating code associated with the user interface element, code associated with the service consuming element, and code associated with the description of the connector connecting between the user interface element and the service consuming element.

13. The computer readable storage medium of claim 12 further comprising instructions for compiling the code into an application.

14. The computer readable storage medium of claim 12 further comprising instructions for deploying an application based on the code.

15. The computer readable storage medium of claim 12 wherein the service is selected from the group consisting of: reading all records from the spreadsheet; reading a record from the spreadsheet; adding a record to the spreadsheet; updating a record in the spreadsheet; deleting a record from the spreadsheet; updating a multiplicity of records; and a service provided by the spreadsheet.

16. The computer readable storage medium of claim 12 wherein the application is executed as a web application.

17. The computer readable storage medium of claim 12 wherein the application is executed in a cloud computing arrangement.
